(19) United States
(12) Patent Application Publication
(10) Pub. No.: US 2022/0391816 A1
(43) Pub. Date: Dec. 8, 2022

(54) DISPLAY METHOD AND INFORMATION PROCESSING APPARATUS

(71) Applicant: FUJITSU LIMITED, Kawasaki-shi (JP)

(72) Inventors: Taichi Hasegawa, Kita (JP); Yasunori Abe, Kawasaki (JP); Tsuyoshi Uchida, Kawasaki (JP); Hirokazu Kondo, Nagaizumi (JP)

(73) Assignee: FUJITSU LIMITED, Kawasaki-shi (JP)

(21) Appl. No.: 17/700,896

(22) Filed: Mar. 22, 2022

(30) Foreign Application Priority Data
Jun. 4, 2021 (JP) 2021-094692

(51) Int. Cl. G06Q 10/06; G06V 40/16; G06V 20/52

(52) U.S. Cl. CPC G06Q 10/063114; G06Q 10/063112; G06V 40/169; G06V 20/52

(57) ABSTRACT

A non-transitory computer-readable recording medium stores a program for causing a computer to execute a process, the process includes identifying a working status of each of plural members based on a work volume of each of the plural members, determining a priority for each of the plural members as an assistance request destination based on the identified working status of each of the plural members, and displaying the plural members as candidates of the assistance request destination based on the determined priority for each of the plural members.

### CROSS-REFERENCE TO RELATED APPLICATION

This application is based upon and claims the benefit of priority of the prior Japanese Patent Application No. 2021-94692, filed on Jun. 4, 2021, the entire contents of which are incorporated herein by reference.

### FIELD

The embodiment discussed herein is related to a display method and an information processing apparatus.

### BACKGROUND

In recent years, promotion of teleworking has been significantly increasing the number of workers remotely working. For example, the members of a team performing a certain project remotely work at different places in some cases. In such a case, one of the members may get stuck at work during remote working and ask another member for assistance.

One of the prior techniques detects the state of work stagnation of a worker by analyzing with an operation terminal, operations for input devices as well as the situation of the display screen and the video of the worker captured with a camera to analyze multiple monitoring features. Another technique creates, based on information representing the results of business activities of a target person, a degree of relevance which is a numerical relevance between the target person and the business activities and displays a relevance chart that correlates a person object indicating the target person with business activity objects indicating the contents of plural business activities, in a style reflecting the numerical degree of relevance.

Still another technique stores 3D images of employees, rooms, and equipment and displays in a display device, a VR image synthesized based on VR information and the 3D images of employees, rooms, and equipment. Still another technique acquires a task-involved person which is determined based on working situation information of a worker and task information concerning the worker's task, from the task information; creates situation information concerning the worker's task based on the working situation information and task information; and discloses the task situation information to the task-involved person.

Japanese Laid-open Patent Publication No. 2010-140164, Japanese Laid-open Patent Publication No. 2014-119856, Japanese Laid-open Patent Publication No. 2019-128683, and Japanese Laid-open Patent Publication No. 2006-65436 are disclosed as related art.

### SUMMARY

According to an aspect of the embodiment, a non-transitory computer-readable recording medium stores a program for causing a computer to execute a process, the process includes identifying a working status of each of plural members based on a work volume of each of the plural members, determining a priority for each of the plural members as an assistance request destination based on the identified working status of each of the plural members, and displaying the plural members as candidates of the assistance request destination based on the determined priority for each of the plural members.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a display method according to an embodiment;

FIG. 2 is a diagram illustrating a system configuration example of a search display system;

FIG. 3 is a diagram illustrating a hardware configuration example of a search display apparatus;

FIG. 4 is a diagram illustrating a hardware configuration example of a client terminal;

FIG. 5 is a diagram illustrating an example of stored data in a member management DB;

FIG. 6 is a diagram illustrating an example of stored data in a work volume management DB;

FIG. 7 is a diagram illustrating an example of stored data in a weight table;

FIG. 8 is a diagram illustrating an example of stored data in a working status classification table;

FIG. 9 is a diagram illustrating a screen example of a management portal screen;

FIG. 10 is a diagram illustrating a functional configuration example of the search display apparatus;

FIG. 11 is a diagram illustrating a specific example of a display image;

FIG. 12 is a diagram illustrating a screen example of a display portal screen (No. 1);

FIG. 13 is a diagram illustrating another screen example of the display portal screen (No. 2);

FIG. 14 is a diagram illustrating still another screen example of the display portal screen (No. 3);

FIG. 15 is a diagram illustrating still another screen example of a display portal screen (No. 4);

FIG. 16 is a flowchart illustrating an example of a working status display processing of the search display apparatus; and

FIG. 17 is a flowchart illustrating an example of a search display processing of the search display apparatus.

### DESCRIPTION OF EMBODIMENT

When a member is stuck at work or in another difficult situation, the prior arts have difficulty in retrieving a member suitable for a request to assist the stuck member. For example, in a case where human resource search is executed based on past careers and abilities of members, there is possible that a member not suitable for a helper comes up depending on the member's working status.

With reference to the drawings, an embodiment will be described in detail below.

### Embodiment

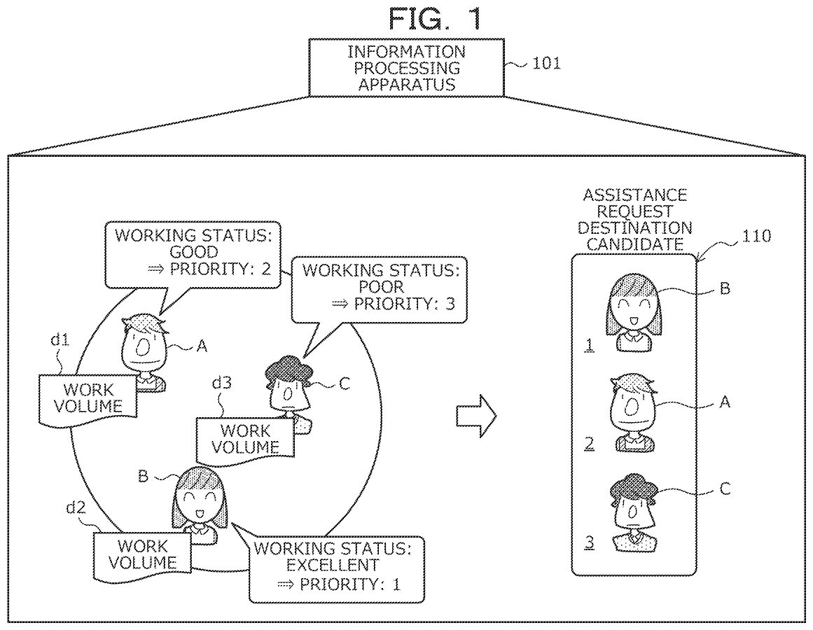

FIG. 1 is a diagram illustrating an example of a display method according to the embodiment. In FIG. 1, an information processing apparatus 101 is a computer that assists retrieval of members to be requested to assist. The members are people who belong to a group, for example, such as a company, a department, a project team, a school, or a party.

During remote working, one of the members may get stuck at work and ask another member for assistance. Remote working is one of work arrangements, in which employees work in places other than offices, for example, such as at home, using information communication technologies. For requesting another member to assist, the destination to be requested to assist may be retrieved based on the past carrier and ability of each member.

However, a member not suitable for a helper (an assistant) could be hit depending on the member's working status. Search parameters request to be entered manually. The working status of each member depends on, for example, the work progress, physical condition, feeling, or the like of the member. In a case requesting another member to assist, it is preferable to request a member who is in a good working status.

As the way to know the situations of other members during remote working, for example, video calling and chatting may be used. However, there is the case that video images are not enough for the member requesting an assistance to check the work progress, physical condition, and the like of another member, for example, so that the member requesting an assistance sometimes will not determine the working status of the other members.

In video calling, the screen is divided by plural members for displaying videos thereof. As the number of members increases, the image of each member decreases in size, which makes it difficult to check the working status of each member. In chatting, the member's working status may be checked only through one-to-one conversation.

This embodiment will describe a display method that facilitates retrieving from plural members, a member suitable for an assistance request destination when one of the members gets stuck at work and requests another member to assist, for example. A processing example of the information processing apparatus 101 will be described below.

(1) The information processing apparatus 101 identifies the working status of each of plural members based on the work volume thereof. The work volume of each member includes, for example, a page transition amount (corresponding to the number of page transitions, for example) during use of browser software, an operation amount for an input device (a keyboard, a mouse, and the like), and the like.

In the example of FIG. 1, the plural members are “members A, B, and C”. In this case, the information processing apparatus 101 identifies the working status of each of the members A, B, and C based on work volumes d1, d2, and d3 of the members A, B, and C, for example. Here, it is assumed that the working status of the member A is identified as “good”; the working status of the member B, “excellent”; and the working status of the member C, “poor”.

The information processing apparatus 101 may, for example, identify the working status of the members A, B, and C by acquiring information representing the working status of the members A, B, and C based on the work volumes d1, d2, and d3 thereof from another computer.

(2) The information processing apparatus 101 determines priorities for each of plural members as the assistance request destination based on the identified working status of each of the plural members. Specifically, for example, the information processing apparatus 101 gives a higher priority as the assistance request destination to a member in a better working status.

In the example of FIG. 1, the priority of the member A is set to “2”, the priority of the member B, “1”; and the priority of the member C, “3”. A smaller priority value indicates higher priority.

(3) The information processing apparatus 101 displays the plural members as candidates for the assistance request destination based on the priorities determined for each of the plural members. Specifically, for example, the information processing apparatus 101 sorts the plural members in the determined order of priority and displays the sorted plural members as candidates for the assistance request destination.

In the example of FIG. 1, an assistance request destination candidate 110 is displayed as a result of sorting the members A, B, and C in order of priority. The assistance request destination candidate 110 indicates candidates for the assistance request destination sorted in order of priority, “(1) member B, (2) member A, (3) member C”.

According to the information processing apparatus 101, plural members are displayed as candidates of the assistance request destination based on the priority as the assistance request destination which is determined from the working status depending on the work volume of each of the plural members. The information processing apparatus 101 facilitates retrieval of members suitable for the assistance request destination.

In the example of FIG. 1, a member who gets stuck at work and retrieves the assistance request destination from the members A, B, and C is able to determine that the member B is the most suitable for the assistance request destination.

(System Configuration Example of Search Display System)

The system configuration example of a search display system 200 according to the embodiment will be described. The case where the information processing apparatus 101 is applied to a search display apparatus 201 will be described as an example. The search display system 200 is applied to, for example, a computer system that monitors the working status of workers.

In the following description, there is the case that members whose working status is being monitored are referred to as “members M1 to Mn (n: a natural number not less than 2)”, and arbitrary member of the members M1 to Mn may be referred to as a “member Mi (i=1, 2, . . . , n)”. There is the case that the client terminal used by the member Mi may be referred to as a “client terminal Ti”, and the sensing device used by the member Mi may be referred to as a “sensing device Ci”.

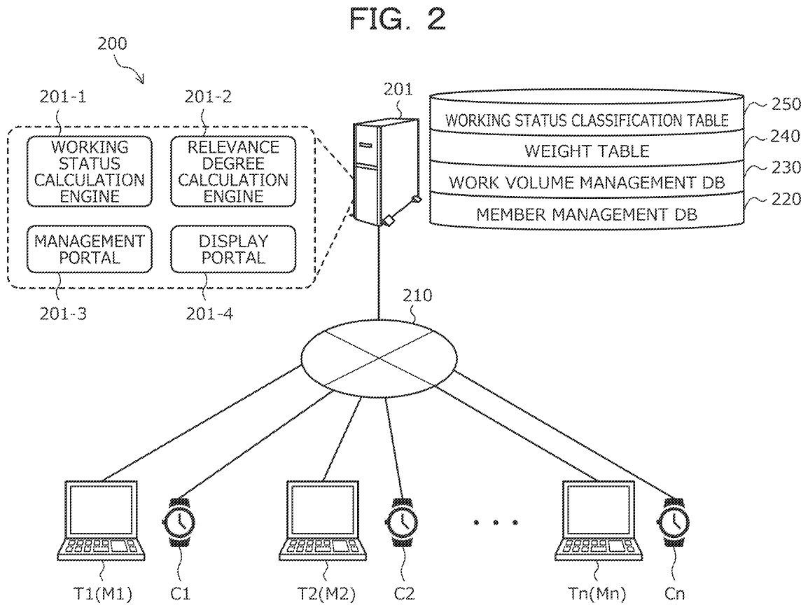

FIG. 2 is a diagram illustrating a system configuration example of the search display system 200. In FIG. 2, the search display system 200 includes the search display apparatus 201, client terminals T1 to Tn, and sensing devices C1 to Cn. In the search display system 200, the search display apparatus 201, the client terminals Ti to Tn, and the sensing devices C1 to Cn are coupled to each other via a wired or wireless network 210. The network 210 is, for example, the Internet, a local area network (LAN), a wide area network (WAN), or the like.

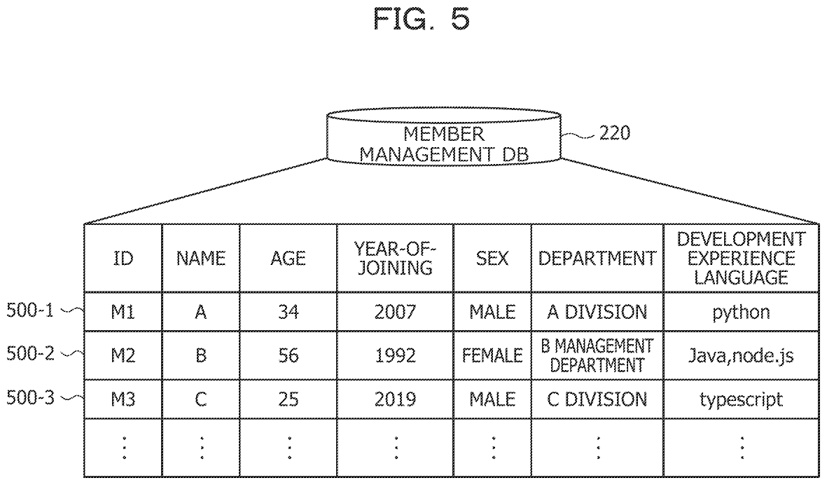

The search display apparatus 201 includes a member management database (DB) 220, a work volume management DB 230, a weight table 240, and a working status classification table 250 and assists retrieval of members as the assistance request destination. The search display apparatus 201 is a server, for example. The stored data in various DBs and the like 220, 230, 240, and 250 will be described later with reference to FIGS. 5 to 8.

The client terminal Ti is a computer used by the member Mi. The members M1 to Mn are, for example, employees of the same company, members of the same project team, or the like. The client terminal Ti is, for example, a personal computer (PC), a tablet PC, a smartphone, or the like.

The members M1 to Mn include, for example, a manager of the search display system 200. The manager, for example, monitors the working status of the other members. The computer used by the manager may be a dedicated terminal different from the client terminal Ti.

The sensing device Ci is a body sensor which is worn by the member Mi and measures body information of the member Mi. The body information includes, for example, the heart rate, body temperature, or the like. The sensing device Ci is, for example, a wristband-type wearable terminal worn on an arm or another part of the member Mi.

The sensing device Ci may establish, for example, short-range wireless communication (wireless LAN, Bluetooth, or the like, for example) with the client terminal Ti. Bluetooth is a registered trademark. In this case, the sensing device Ci is, for example, communicable with the search display apparatus 201 via the client terminal Ti.

In the search display system 200, the search display apparatus 201 includes, for example, a working status calculation engine 201-1, a relevance degree calculation engine 201-2, a management portal 201-3, and a display portal 201-4. The working status calculation engine 201-1 is a program to calculate the working status of each member.

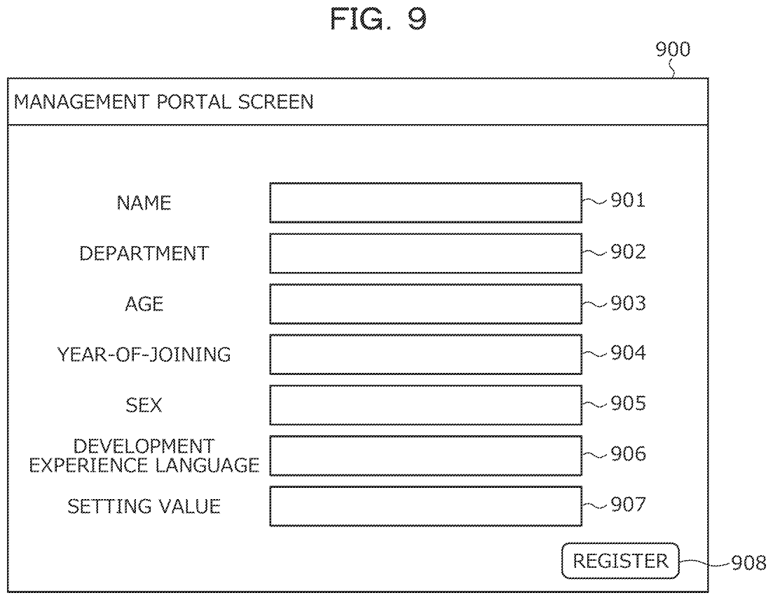

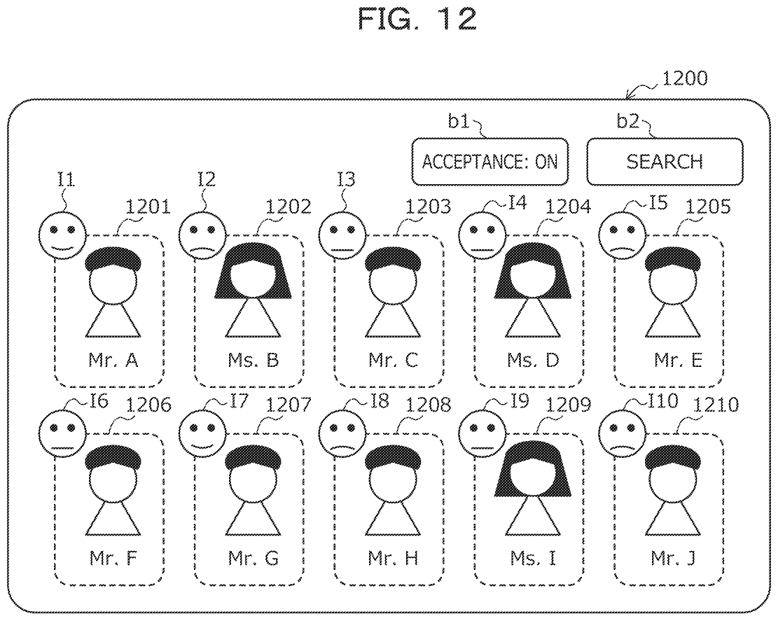

The relevance degree calculation engine 201-2 is a program to calculate the degree of relevance between the members. The management portal 201-3 is, for example, a program to display a management portal screen 900 as illustrated in FIG. 9 described later. The display portal 201-4 is, for example, a program to display a display portal screen 1200 as illustrated in FIG. 12 described later.

Here, although the client terminal Ti and the sensing device Ci are separately provided, this is not the only case. For example, the client terminal Ti may be configured to include a body sensor (corresponding to the sensing device Ci) measuring the member's body information.

(Hardware Configuration Example of Search Display Apparatus)

A hardware configuration example of the search display apparatus 201 will be described.

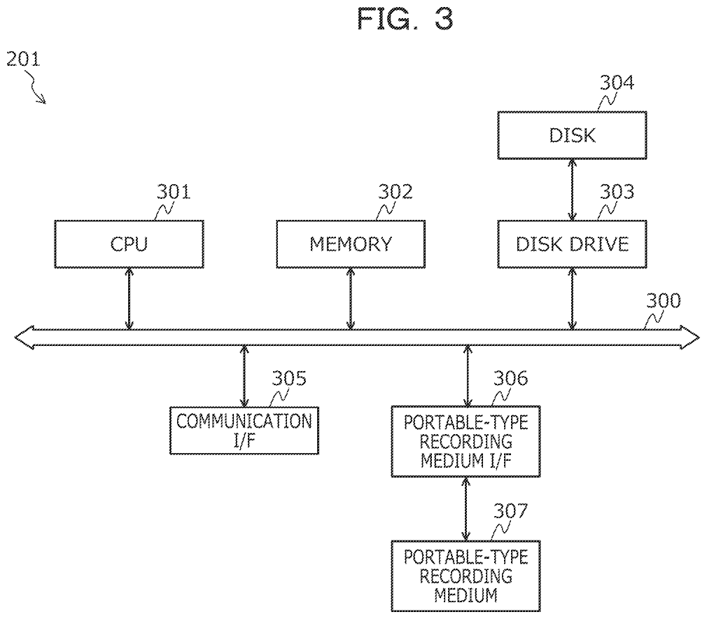

FIG. 3 is a diagram illustrating a hardware configuration example of the search display apparatus 201. In FIG. 3, the search display apparatus 201 includes a central processing unit (CPU) 301, a memory 302, a disk drive 303, a disk 304, a communication interface (I/F) 305, a portable-type recording medium I/F 306, and a portable-type recording medium 307. These components are coupled to one another through a bus 300.

The CPU 301 controls the entirety of the search display apparatus 201. The CPU 301 may include multiple cores. The memory 302 includes, for example, a read-only memory (ROM), a random-access memory (RAM), a flash ROM, and the like. For example, the flash ROM stores a program of an operating system (OS), the ROM stores application programs, and the RAM is used as a work area for the CPU 301. The programs stored in the memory 302 are loaded by the CPU 301, thereby causing the CPU 301 to execute coded processing.

The disk drive 303 controls reading and writing of data from and to the disk 304 in accordance with the control of the CPU 301. The disk 304 stores the data written under the control of the disk drive 303. Examples of the disk 304 include a magnetic disk, an optical disk, and the like.

The communication I/F 305 is coupled to the network 210 via a communication line, and is coupled to an external computer (for example, the client terminal Ti and sensing device C illustrated in FIG. 2) via the network 210. The communication I/F 305 functions as an interface between the network 210 and the inside of the search display apparatus 201 and controls input and output of data from and to the external computer. As the communication I/F 305, for example, a modem, a LAN adapter, or the like may be used.

The portable-type recording medium I/F 306 controls reading and writing of data from and to the portable-type recording medium 307 in accordance with the control of the CPU 301. The portable-type recording medium 307 stores the data written under the control of the portable-type recording medium I/F 306. Examples of the portable-type recording medium 307 include a compact disk (CD)-ROM, a Digital Versatile Disk (DVD), a Universal Serial Bus (USB) memory, and the like.

In addition to the above-described components, for example, the search display apparatus 201 may include an input device, a display, and the like.

(Hardware Configuration Example of Client Terminal)

The following describes a hardware configuration example of the client terminal Ti.

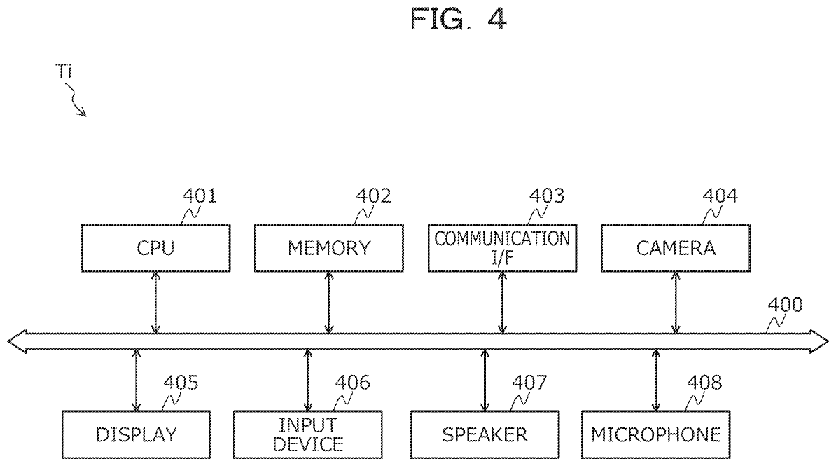

FIG. 4 is a diagram illustrating a hardware configuration example of the client terminal Ti. In FIG. 4, the client terminal Ti includes a CPU 401, a memory 402, a communication I/F 403, a camera 404, a display 405, an input device 406, a speaker 407, and a microphone 408. These components are coupled to one another through a bus 400.

The CPU 401 controls the entirety of the client terminal Ti. The CPU 401 may include multiple cores. The memory 402 is a storage unit that includes, for example, ROM, RAM, flash ROM, and the like. For instance, the flash ROM and the ROM store various programs, and the RAM is used as a work area for the CPU 401. The program stored in the memory 402 is loaded by the CPU 401, thereby causing the CPU 401 to execute coded processing.

The communication I/F 403 is coupled to the network 210 via a communication line, and is coupled to an external computer (for example, the search display apparatus 201 and the sensing device Ci) via the network 210. The communication I/F 403 functions as an interface between the network 210 and the inside of the client terminal and controls the input and output of data from and to external apparatuses.

The camera 404 is an imaging apparatus which captures an image (still image or video) and outputs image data. The camera 404 is, for example, mounted at a position where the camera 404 may capture the face of the user (the member Mi) that uses the client terminal Ti.

The display 405 is a display device that displays data such as a cursor, icons, and a toolbox, and also, documents, images, functional information, and the like. In the display 405, for example, the face of a robot may be outputted. For the display 405, for example, a liquid crystal display, an organic electroluminescence (EL) display, or the like may be employed.

The input device 406 has keys for inputting characters, numbers, various instructions, and the like and is used for inputting data. The input device 406 may be a touch-panel input pad, a numeric keypad, or the like or may be a keyboard, a mouse, or the like. The speaker 407 converts an electrical signal to sound and outputs the sound. The microphone 408 receives sound and converts the sound into an electrical signal.

The client terminal Ti unnecessarily includes, for example, the speaker 407 and microphone 408 among the above-described components. In addition to the above-described components, the client terminal Ti may include, for example, a hard disk drive (HDD), a solid-state drive (SSD), a short-range wireless communication I/F, a portable-type recording medium I/F, a portable-type recording medium, and the like. The sensing device Ci illustrated in FIG. 2 may also be implemented by a hardware configuration similar to that of the client terminal Ti. The sensing device Ci includes, for example, a sensor that measures body information of the member Mi in addition to the above-described components.

(Stored Data in DBs and the Like)

With reference to FIGS. 5 to 8, description is provided for stored data in the DBs and the like 220, 230, 240, and 250 included in the search display apparatus 201. The DBs and the like 220, 230, 240, and 250 are implemented, for example, by the storage devices such as the memory 302 and the disk 304 in the search display apparatus 201 illustrated in FIG. 3.

FIG. 5 is a diagram illustrating an example of stored data in the member management DB 220. In FIG. 5, the member management DB 220 includes fields of: ID, name, age, year-of-joining, sex, department, and development experience language. When information is set in each field, the member management DB 220 stores member management information in records (member management information sets 500-1 to 500-3, for example).

The ID indicates an identifier for uniquely identifying the member Mi. The name indicates the name of the member Mi. The age indicates the age of the member Mi. The year-of-joining indicates the year when the member Mi joined the company. The sex indicates the sex of the member Mi. The department indicates the department to which the member Mi belongs. The development experience language indicates a development language that the member Mi has used before. Java is a registered trademark.

The age, year-of-joining, sex, department, and development experience language, for example, among the member management information are examples of attribute information representing the attributes of the member Mi.

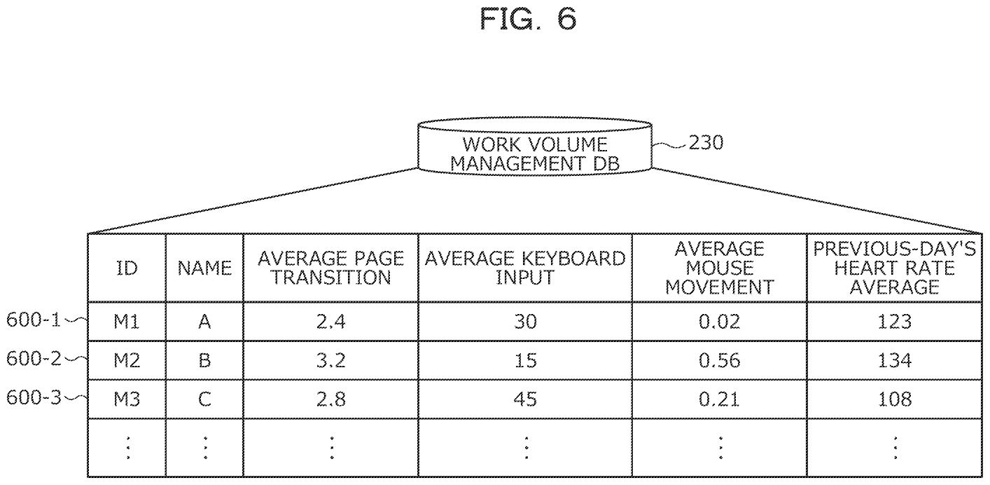

FIG. 6 is a diagram illustrating an example of stored data in the work volume management DB 230. In FIG. 6, the work volume management DB 230 includes fields of: ID, name, average page transition, average keyboard input, average mouse movement, and previous-day's heart rate average. When information is set in each field, the work volume management DB 230 stores work volume management information in records (work volume management information sets 600-1 to 600-3, for example).

The ID indicates an identifier for uniquely identifying the member Mi. The name indicates the name of the member Mi. The average page transition, average keyboard input, and average mouse movement are examples of a past average work volume of the member Mi. The average page transition indicates the average page transition amount of the member Mi for 30 seconds (unit: transitions). The average keyboard input indicates the average number of keyboard inputs by the member Mi for 30 seconds (unit: inputs).

The average mouse movement indicates the average amount (distance) of mouse movement of the member Mi for 30 seconds (unit: m). The previous-day's heart rate average indicates the average heart rate of the member Mi of the previous day (unit: bpm). The average page transition, average keyboard input, and average mouse movement are, respectively, set based on the page transition amount, the number of keyboard inputs, and the amount of mouse movement of the member Mi for a past time period (for example, the last one month). The previous-day's heart rate average is set based on the previous-day's heart rate of the member Mi.

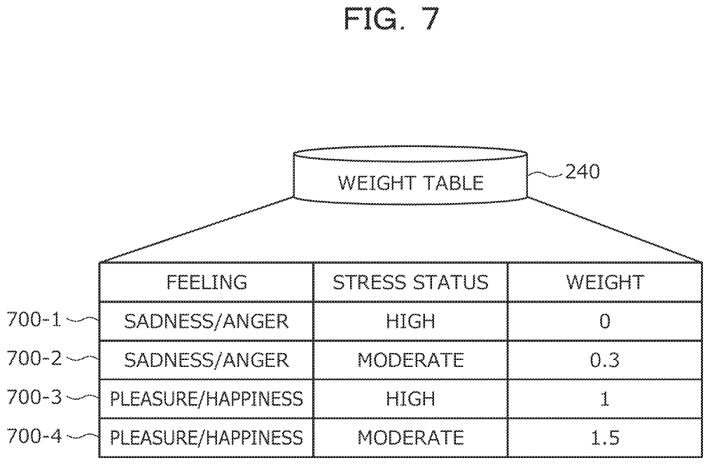

FIG. 7 is a diagram illustrating an example of stored data in the weight table 240. In FIG. 7, the weight table 240 includes fields of: feeling, stress status, and weight. When information is set in each field, the weight table 240 stores weight information sets 700-1 to 700-4 in records.

The feeling represents feeling of pleasure, anger, sadness, and happiness. The feeling “sadness/anger” indicates sadness or anger. The feeling “pleasure/happiness” indicates pleasure or happiness. The stress status represents the level of mental tension. The stress status is represented by, for example, “high” or “moderate”. The stress status “high” indicates that the level of mental tension is high. The stress status “moderate” indicates that the level of mental tension is not high.

The weight is a number for weighting the work progress in the light of feeling and stress status. For example, the working status of the member Mi is calculated by multiplying the work progress of the member Mi by a weight according to the feeling and stress status of the member Mi. For example, the weight information set 700-1 indicates the weight “0” in the case of the feeling “sadness/anger” and the stress status “high”.

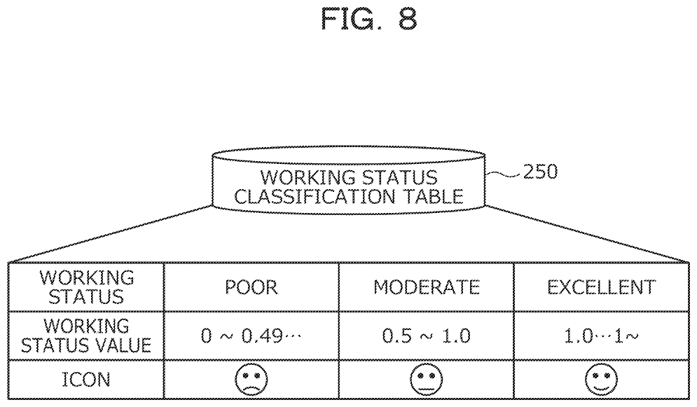

FIG. 8 is a diagram illustrating an example of stored data in the working status classification table 250. In FIG. 8, the working status classification table 250 represents a correspondence relationship between the working status, working status value, and icons. The working status is the working status of each member and is classified into excellent, good, or poor, for example. The working status value is a numerical value of the working status of each member. Here, “0-0.49 . . . ” indicates not less than 0 and less than 0.5. “0.5-1.0” indicates not less than 0.5 and less than 1.0. “1.0 . . . 1-” indicates not less than 1.

The icons are images representing the working status of the member Mi. As the icons, for example, icons that enable intuitive judgement whether or not the working status of the member is excellent are set. For example, the working status “excellent” is represented by a smiling face icon (a face mark). The working status “good” is represented by an expressionless face icon. The working status “poor” is represented by a frowning face icon.

(Screen Example of Management Portal Screen)

Using FIG. 9, a screen example of a management portal screen displayed in the display 405 of the client terminal Ti will be described. The management portal screen is, for example, operated by the manager of the search display system 200. The management portal screen is, for example, displayed by the management portal 201-3 of the search display apparatus 201 (see FIG. 2).

FIG. 9 is a diagram illustrating a screen example of the management portal screen. In FIG. 9, a management portal screen 900 is an operation screen for inputting pre-input parameters of each member Mi or setting a value (weight) to be used in calculating the working status. FIG. 9 selectively displays a part of the management portal screen 900.

In the management portal screen 900, for example, selecting a box 901 by an operation input of the user (manager) with the input device 406 illustrated in FIG. 4 enables input of the name of the member Mi. In the management portal screen 900, selecting a box 902 enables input of the department of the member Mi.

In the management portal screen 900, selecting a box 903 enables input of the age of the member Mi. In the management portal screen 900, selecting a box 904 enables input of the year-of-joining of the member Mi. In the management portal screen 900, selecting a box 905 enables input of the sex of the member Mi.

In the management portal screen 900, selecting a box 906 enables input of a development language that the member Mi has used before. In the box 906, plural development languages may be inputted with commas therebetween, for example.

In the management portal screen 900, when a register button 908 is selected with various information inputted in the respective boxes 901 to 906, new member management information is newly registered in the member management DB 220 according to the information inputted in the respective boxes 901 to 906.

In the management portal screen 900, selecting a box 907 enables input of a setting value (weight) to be used in calculating the working status. In the box 907, for example, it is possible to input weights corresponding to a combination of feeling and stress status with a comma therebetween. In the management portal screen 900, when the register button 908 is selected with the information inputted in the box 907, the stored data in the weight table 240 is updated according to the information inputted in the box 907.

(Functional Configuration Example of Search Display Apparatus)

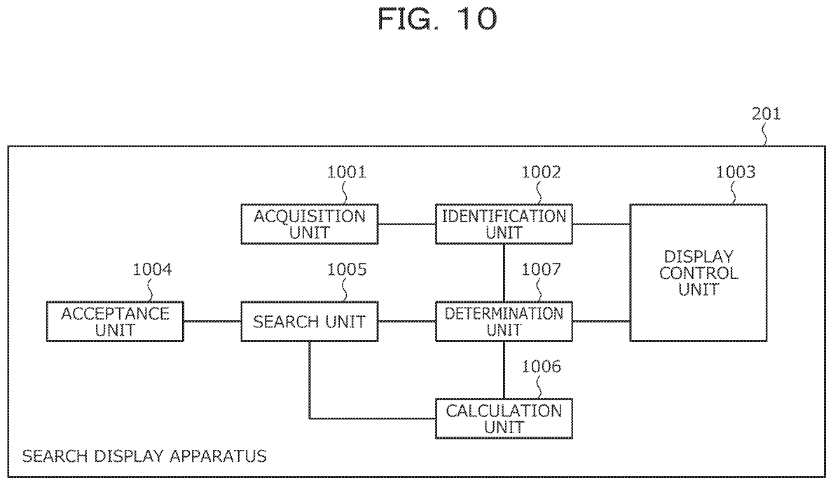

FIG. 10 is a diagram illustrating a functional configuration example of the search display apparatus 201. In FIG. 10, the search display apparatus 201 includes an acquisition unit 1001, an identification unit 1002, a display control unit 1003, an acceptance unit 1004, a search unit 1005, a calculation unit 1006, and a determination unit 1007. The acquisition unit 1001 to the determination unit 1007 are functions constituting a control unit, and these functions are each implemented, for example, by causing the CPU 301 to execute a program stored in the storage device such as the memory 302, the disk 304, or the portable-type recording medium 307 illustrated in FIG. 3 or by using the communication I/F 305. The processing results obtained by these functional units are stored, for example, in the storage device such as the memory 302 or the disk 304.

The acquisition unit 1001 acquires the work volume of the member Mi. The acquired work volume of the member Mi is, for example, the work volume of the member Mi per unit time. The unit time may be set to arbitrary time and is, for example, set to a time of about 30 to 60 seconds. Specifically, for each member Mi of the members M1 to Mn, the acquisition unit 1001 acquires the work volume of the member Mi, for example.

The work volume of the member Mi is, for example, the page transition amount during use of browser software. Browser software is software for browsing web pages. The page transition amount may be represented by the number of changes in Uniform Resource Locator (URL) specified in browser software, for example.

The page transition amount may be represented by the number of transitions in the same page (the number of changes in displayed contents in the page) by scrolling or the like. The page transition amount may be represented by the sum of the number of changes in URL specified in browser software and the number of transitions in the same page.

As an example, it is assumed that the unit time is set to “30 seconds” and the work volume of the member Mi for last 30 seconds is acquired. In this case, the acquisition unit 1001 acquires a display image from the client terminal Ti, for example, every 5 seconds. The display image represents the contents displayed on the display 405 of the client terminal Ti (see FIG. 4).

The client terminal Ti, for example, acquires a display image by recording the contents displayed on the display 405 (see FIG. 4) as a still image through screenshot (screen capture). The client terminal Ti sends the acquired display image to the search display apparatus 201.

The acquisition unit 1001 compares the display image currently acquired with the display image previously acquired. If determining that the display images are different, the acquisition unit 1001 increments the page transition amount. The acquisition unit 1001 acquires the page transition amount (six transitions at maximum) for 30 seconds as the work volume of the member Mi per unit time.

If the page transition amount for 30 seconds is “0”, the acquisition unit 1001 acquires, for example, the page transition amount of the member Mi including the page transition amount for the previous 30 seconds.

For example, it is assumed that the page transition amount in the current 30-second period is “0” and the page transition amount in the previous 30-second period is “2”. In this case, based on the page transition amount “2” for last 60 seconds, the acquisition unit 1001 acquires “1 (=2/(60 seconds/30 seconds))” as the page transition amount of the member Mi per 30 seconds. For example, it is assumed that the page transition amount is “0” in the current 30-second period, “0” in the previous 30-second period, and “2” in the 30-second period preceding the previous 30-second period. In this case, based on the page transition amount “2” for last 90 seconds, the acquisition unit 1001 acquires “0.7 (˜2/(90 seconds/30 seconds))” as the work volume of the member Mi per 30 seconds.

The page transition amount of each member Mi per unit time (30 seconds, for example) is accumulated in the storage device, for example, such as the memory 302 and the disk 304. The average page transition of each member Mi in the work volume management DB 230 is updated, for example, at regular intervals (every month, for example) based on the accumulated page transition amount of each of the member Mi per unit time.

The work volume of the member Mi may be, for example, an amount of operation performed using the input device 406 of the client terminal Ti (see FIG. 4). The input device 406 includes, for example, a keyboard and a mouse. The operation amount for the input device 406 may be, for example, represented by the amount of mouse movement. The operation amount for the input device 406 may be, for example, represented by the amount of keyboard input (the number of keyboard inputs). The operation amount for the input device 406 may be, for example, represented by both the amount of mouse movement and the amount of keyboard input.

Specifically, for example, the acquisition unit 1001 acquires an operation log for the member Mi during use of a different type of software from browser software. Examples of the different type of software include program development software, word processing software, and spreadsheet software. The acquisition unit 1001 analyzes the acquired operation log to acquire the amount of mouse movement for last 30 seconds and the amount of keyboard input for last 30 seconds as the work volume of the member Mi per unit time (30 seconds).

Whether or not the member Mi is using browser software is, for example, determined by analyzing the display image of the client terminal Ti. The acquisition unit 1001 may determine that the member Mi is using browser software if a predetermined pattern is detected from the display image of the client terminal Ti, for example. The acquisition unit 1001 may determine whether or not the display image is an image during use of browser software, by using a technique, such as machine learning.

The calculation of the page transition amount of the member Mi per unit time and the operation amount of the member Mi for the input device 406 per unit time may be, for example, performed by the client terminal Ti. In this case, the acquisition unit 1001 acquires the page transition amount of the member Mi per unit time and the operation amount of the member Mi for the input device 406 per unit time by receiving the result of calculation from the client terminal Ti.

The process of acquiring the work volume of the member Mi in the acquisition unit 1001 is, for example, regularly executed at intervals of about 30 to 60 seconds. The most recent work volume of the member Mi per unit time therefore may be acquired regularly.

The acquisition unit 1001 may acquire body information of the member Mi. The body information of the member Mi includes, for example, the heart rate, body temperature, or the like of the member Mi. Specifically, the acquisition unit 1001 acquires from the sensing device Ci, the body information of the member Mi measured by the sensing device Ci illustrated in FIG. 2, for example. The acquisition unit 1001 may acquire the body information of the member Mi measured by the sensing device Ci, through the client terminal Ti.

The acquisition unit 1001 may acquire the captured image of the member Mi. The captured image of the member Mi includes, for example, a face image of the member Mi. The face image of the member Mi is, for example, captured by the camera 404 of the client terminal Ti (see FIG. 4). Specifically, the acquisition unit 1001 acquires from the client terminal Ti, the captured image (face image) of the member Mi captured by the camera 404, for example.

The identification unit 1002 identifies the working status of the member Mi based on the acquired work volume of the member Mi. Specifically, for each member Mi of the members M1 to Mn, the identification unit 1002 identifies the working status of each of the member Mi based on the work volume thereof, for example. The identification unit 1002 may identify the working status of the member Mi based on the page transition amount during use of browser software, for example. The identification unit 1002 may identify the working status of the member Mi based on the operation amount for the input device 406.

To be more specific, for example, when the member Mi is using browser software, the identification unit 1002 identifies the average page transition of the member Mi with reference to the work volume management DB 230 illustrated in FIG. 6. The average page transition corresponds to a past average page transition amount (work volume) of the member Mi per unit time.

The identification unit 1002 calculates the work progress of the member Mi based on the acquired page transition amount (work volume) of the member Mi per unit time and the identified average page transition of the member Mi. The average page transition of the member Mi may be set to a previously prepared setting value.

The work progress is an index value indicating the rate of progress of the member Mi. The work progress based on the page transition amount of the member Mi per unit time may be calculated using the following expression (1), for example. Here, during use of browser software, when the most recent page transition amount is smaller, it is determined that information research or similar work has progressed and the rate of progress is higher.

work progress=average page transition of member Mi/page transition amount of member Mi (1)

While the member Mi is using a different type of software from browser software, the identification unit 1002 identifies the average keyboard input and average mouse movement of the member Mi with reference to the work volume management DB 230. The average keyboard input and average mouse movement correspond to the past average amounts of keyboard input and mouse movement of the member Mi per unit time, respectively. The average keyboard input and average mouse movement of the member Mi may be set to previously prepared setting values.

The identification unit 1002 calculates the work progress of the member Mi based on the acquired amounts of keyboard input and mouse movement of the member Mi per unit time and the identified average keyboard input and average mouse movement of the member Mi. The operation for the input device 406 includes composite operations for the keyboard and mouse, for example.

The identification unit 1002, for example, calculates the work progress of the member Mi based on a mouse movement ratio and a keyboard input ratio. The mouse movement ratio is, for example, the ratio of the most recent amount of mouse movement per unit time to the past amount of mouse movement per unit time and is expressed by “amount of mouse movement of member Mi/average mouse movement of member Mi”.

The keyboard input ratio is, for example, the ratio of the most recent amount of keyboard input per unit time to the past amount of keyboard input per unit and is expressed by “amount of keyboard input of member Mi/average keyboard input of member Mi”. The mouse movement ratio and keyboard input ratio represent how much the current operation amount has increased or decreased compared to the past operation amount and serve as an index to determine the rate of progress.

In the case of the composite operations for the keyboard and mouse, the operation time of the input device 406 includes mouse input time and keyboard input time. The identification unit 1002 calculates the mouse input time and keyboard input time in unit time with reference to the acquired operation log.

Specifically, for example, the identification unit 1002 determines the operation time of the mouse as a time period from when the mouse is operated to when the keyboard is operated next. The identification unit 1002 determines the operation time of the keyboard as a time period from when the keyboard is operated to when the mouse is operated next. The identification unit 1002 calculates the total operation time of the mouse in unit time as the mouse input time and the total operation time of the keyboard in unit time as the keyboard input time.

The identification unit 1002 calculates the work progress of the member Mi using the following expression (2) based on the mouse movement ratio, the keyboard input ratio, and mouse and keyboard input times. Here, during use of a different type of software from browser software, when the current operation amount (the amounts of mouse movement and keyboard input) is increased more from the past operation amount, the rate of progress is determined to be higher.

work progress={(mouse input time/unit time)×mouse movement ratio+(keyboard input time/unit time)×keyboard input ratio} (2)

The identification unit 1002 identifies the working status of the member Mi based on the calculated work progress. Specifically, for example, the identification unit 1002 may identify the working status of the member Mi as any status of “excellent”, “good”, and “poor” according to the calculated work progress.

To be more specific, for example, using the calculated work progress as the working status value, the identification unit 1002 identifies the working status of the member Mi as a working status corresponding to the working status value with reference to the working status classification table 250 illustrated in FIG. 8. The identification unit 1002 may identify the working status of the member Mi as the calculated work progress itself.

There is the case that the working status of the member Mi may depend on the stress status of the member Mi. The identification unit 1002 may identify the working status of the member Mi based on the stress status identified according to the body information of the member Mi.

Specifically, for example, the identification unit 1002 identifies the previous-day's heart rate average corresponding to the member Mi with reference to the work volume management DB 230. The identification unit 1002 then identifies the current heart rate of the member Mi with reference to the acquired body information of the member Mi. The identification unit 1002 compares the identified current heart rate with the previous-day's heart rate average to determine whether the current heart rate is higher than the previous-day's average heart rate.

If the current heart rate is higher than the previous-day's heart rate average, the identification unit 1002 identifies the stress status of the member Mi as “high”. The stress status “high” indicates that the level of mental tension is high. If the current heart rate is not higher than the previous-day's heart rate average, the identification unit 1002 identifies the stress status of the member Mi as “moderate”. The stress status “moderate” indicates that the level of mental tension is not high.

The identification unit 1002 may weight the calculated work progress according to the identified stress status of the member Mi. Specifically, for example, when the stress status of the member Mi is “high”, the identification unit 1002 may weight the calculated work progress by multiplying the work progress by a value less than 1.

When the stress status of the member Mi is “moderate”, the identification unit 1002 may weight the calculated work progress by multiplying the work progress by a value not less than 1. The identification unit 1002 is able to identify the working status of the member Mi in the light of not only the work volume of the member Mi but also the stress status of the member Mi.

Here, although the stress status of the member Mi is identified based on the heart rate of the member Mi above by way of example, this is not the only case. For example, the identification unit 1002 may identify the stress status of the member Mi by comparing the body temperature, the amount of exercise, or the like of the member Mi with the previous-day's average thereof.

There is the case that the working status of the member Mi may depend on the feeling of the member Mi. The identification unit 1002 may identify the working status of the member Mi based on the feeling analyzed based on the captured image of the member Mi.

Specifically, for example, the identification unit 1002 analyzes the acquired captured image (face image) of the member Mi to identify the feeling of the member Mi. The feeling is, for example, identified as any feeling of pleasure, anger, sadness, or happiness. The feeling is, for example, analyzed from the movement (state) of face muscles. The method of analyzing the feeling from a face image may use any existing technique.

The identification unit 1002 may weight the calculated work progress according to the identified feeling of the member Mi. Specifically, for example, when the feeling of the member Mi is “anger” or “sadness”, the identification unit 1002 may weight the calculated work progress by multiplying the work progress by a value less than 1.

When the feeling of the member Mi is “pleasure” or “happiness”, the identification unit 1002 may weight the calculated work progress by multiplying the work progress by a value not less than 1. The identification unit 1002 is able to identify the working status of the member Mi in the light of not only the work volume of the member Mi but also the feeling of the member Mi.

To be more specific, for example, the identification unit 1002 identifies the weight corresponding to the identified feeling and stress status of the member Mi with reference to the weight table 240 illustrated in FIG. 7. The identification unit 1002 then weights the calculated work progress by multiplying the work progress by the identified weight. Using the weighted work progress as the working status value, the identification unit 1002 identifies the working status of the member Mi as the working status corresponding to the working status value with reference to the working status classification table 250.

The identification unit 1002 is able to identify the working status of the member Mi in the light of not only the work volume of the member Mi but also the stress status and feeling of the member Mi. An example of identifying the working status of the member Mi will be described later.

The display control unit 1003 displays the members M1 to Mn based on the working status identified for each member Mi of the members M1 to Mn. Specifically, for example, the display control unit 1003 identifies an icon (a face icon) corresponding to the working status of each member Mi with reference to the working status classification table 250.

The display control unit 1003 displays the identified icon (face icon) in association with each member Mi. To be more specific, for example, the display control unit 1003 may display the display portal screen 1200 illustrated in FIG. 12 described later, in each client terminal Ti.

The acceptance unit 1004 accepts a search request for candidates of the assistance request destination. The assistance request destination is a destination to be requested to assist an assistance target member Mj (j=1, 2, . . . , n). The assistance target member Mj is a member to be assisted. The search request for candidates of the assistance request destination is a request to retrieve other members as candidates of the destination to be requested to assist the assistance target member Mj.

Specifically, for example, the acceptance unit 1004 accepts a search request for candidates of the assistance request destination from the client terminal Tj of the assistance target member Mj. The acceptance unit 1004 may be configured to accept a search request for candidates of the assistance request destination from the client terminal Ti of the manager of the search display system 200. The search request for candidates of the assistance request destination includes, for example, the ID of the assistance target member Mj.

The search unit 1005 retrieves candidates of the assistance request destination from the members M1 to Mn. Specifically, for example, in response to the search request for candidates of the assistance request destination, the search unit 1005 may retrieves candidates of the assistance request destination to be requested to assist the assistance target member Mj, based on the attribute information of each member Mi of the members M1 to Mn. The attribute information of the member Mi is, for example, information identifying the age, sex, year-of-joining, department, development experience language, and the like.

The search unit 1005 acquires a display image from the client terminal Tj, for example. Based on the acquired display image, the search unit 1005 determines whether the assistance target member Mj is working on program development. For example, the search unit 1005 may determine whether the display image is an image displayed during work on program development, by using a technique, such as machine learning.

In some cases, the display portal screen 1200 as illustrated in FIG. 12 described later is displayed in the client terminal Tj. In this case, the search unit 1005 acquires a display image with the display portal screen 1200 closed, for example, from the client terminal Tj.

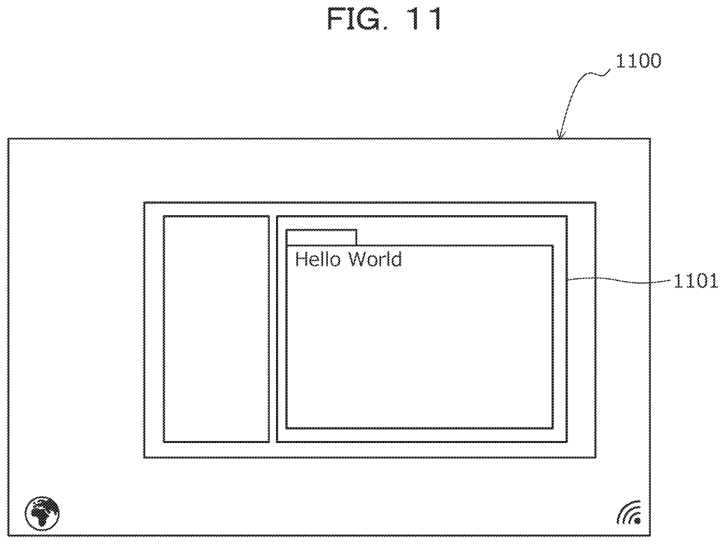

An example of determining whether the assistance target member Mj is working on program development will be described later using FIG. 11.

When the assistance target member Mj is working on program development, the search unit 1005 identifies the development language that the assistance target member Mj is using, based on the acquired display image. The development language is a programing language, for example. Specifically, the search unit 1005 identifies the development language that the assistance target member Mj is using, by analyzing the inputted program code, for example.

The search unit 1005 retrieves from the members M1 to Mn (the monitored members), members who have experience in using the identified development language as candidates of the assistance request destination for the assistance target member Mj. Specifically, for example, with reference to the member management DB 220 illustrated in FIG. 5, the search unit 1005 retrieves the members (except the assistance target member Mj) whose development experience language includes the identified development language.

It is therefore possible to retrieve members who have experience in using the development language that the assistance target member Mj is using, as candidates of the assistance request destination.

When the assistance target member Mj is not working on program development, the search unit 1005 retrieves from the members M1 to Mn (the monitored members), members of the same group as that of the assistance target member Mj, as candidates of the assistance request destination for the assistance target member Mj. Specifically, for example, the search unit 1005 retrieves members (except the assistance target member Mj) whose department is the same as that of the assistance target member Mj with reference to the member management DB 220.

It is therefore possible to retrieve members who belong to the same department as the assistance target member Mj, as candidates of the assistance request destination.

When the assistance target member Mj is not working on program development, the search unit 1005 may retrieve from the members M1 to Mn, members whose year-of-joining is the same as that of the assistance target member Mj, as candidates of the assistance request destination for the assistance target member Mj. When the assistance target member Mj is not working on program development, the search unit 1005 may retrieve from the members M1 to Mn, members who are of the same sex as the assistance target member Mj, as candidates of the assistance request destination for the assistance target member Mj.

When the assistance target member Mj is working on program development, the search unit 1005 may not identify the development language that the assistance target member Mj is using in some cases. In such a case, the search unit 1005 may retrieve from the members M1 to Mn, members whose department (or year-of-joining, sex, or the like) is the same as that of the assistance target member Mj, as candidates of the assistance request destination for the assistance target member Mj.

The calculation unit 1006 calculates the degree of relevance between the retrieved members and the assistance target member Mj. The degree of relevance is an index value indicating how relevant to the assistance target member Mj each of the retrieved members is. Specifically, for example, when the plural members are retrieved as candidates of the assistance request destination, the calculation unit 1006 calculates the degree of relevance between each of the retrieved plural members and the assistance target member Mj, based on the attribute information of each of the plural members and the attribute information of the assistance target member Mj.

To be more specific, for example, the calculation unit 1006 identifies the ages of each of the retrieved plural members and the age of the assistance target member Mj with reference to the member management DB 220. As the degree of relevance between each of the retrieved plural members and the assistance target member Mj, the calculation unit 1006 may calculate the difference in age between each of the retrieved plural member and the assistance target member Mj. As for the year-of-joining, for example, as the degree of relevance between each of the retrieved plural members and the assistance target member Mj, the calculation unit 1006 may calculate the difference in year-of-joining therebetween similarly to the age.

The calculation unit 1006 identifies the sex of each of the retrieved plural members and the sex of the assistance target member Mj with reference to the member management DB 220. The calculation unit 1006 may calculate the degree of relevance by weighting the calculated difference in age for the members of the same sex as that of the assistance target member Mj. As for the department and development experience language, for example, similarly to the sex, the calculation unit 1006 may calculate the degree of relevance by weighting the calculated difference in age for the members whose department or development experience language is the same as that of the assistance target member Mj.

In the following description, there is the case that the plural members retrieved as candidates of the assistance request destination are sometimes referred to as “members M[1] to [m] (m: a natural number not less than 2)”. There is the case that arbitrary one of the members M[1] to [m] is sometimes referred to as a “member M[k] (k=1, 2, . . . , m)”.

Based on the working status identified for each member M[k] of the retrieved members M[1] to [m], the determination unit 1007 determines a priority for each member M[k] as the assistance request destination. Specifically, for example, the determination unit 1007 gives a higher priority as the assistance request destination to the member M[k] in a better working status.

To be more specific, for example, when the working status of the member M[k] is “excellent”, the determination unit 1007 set the priority of the member M[k] to “1”. When the working status of the member M[k] is “good”, the determination unit 1007 sets the priority of the member M[k] to “2”. When the working status of the member M[k] is “poor”, the determination unit 1007 sets the priority of the member M[k] to “3”. A smaller priority value indicates higher priority.

The display control unit 1003 displays the members M[1] to [m] as candidates of the assistance request destination based on the priority determined for each member M[k] of the members M[1] to [m]. Specifically, for example, the display control unit 1003 sorts the members M[1] to [m] in order of the determined priority. The display control unit 1003 displays the sorted members M[1] to [m] as candidates of the assistance request destination in the client terminal that has requested the search (for example, the client terminal Tj of the assistance target member Mj).

The display control unit 1003 may display the members M[1] to [m] as candidates of the assistance request destination based on the priority determined for each member M[k] of the members M[1] to [m] and the calculated degree of relevance. Specifically, for example, in the process of sorting the members M[1] to [m] in order of priority, the display control unit 1003 may rank higher a member of a higher degree of relevance among the members of the same priority.

The display control unit 1003 may sort the members M[1] to [m] in descending order of the degree of relevance, for example. In this case, the display control unit 1003 may rank a member of higher priority higher among the members having the same degree of relevance.

In the process of displaying the members M[1] to [m] as candidates of the assistance request destination, the display control unit 1003 may display icons corresponding to the working status of the respective members M[1] to [m] in association with each of the members M[1] to [m].

Specifically, for example, the display control unit 1003 identifies icons (face icons) corresponding to the working status of each of the members M[1] to [m] with reference to the working status classification table 250. In the process of displaying the sorted members M[1] to [m] as candidates of the assistance request destination, the display control unit 1003 may display the identified icons (face icons) in association with the captured images or names of the respective members M[1] to [m].

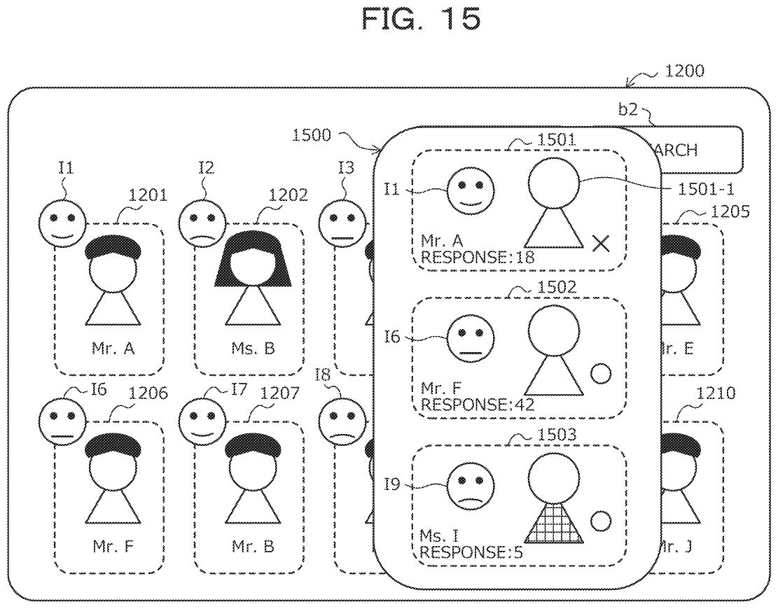

A display example of candidates of the assistance request destination will be described using FIG. 15.

The acceptance unit 1004 may accept a rejection setting from the client terminal Ti. The rejection setting is to reject a request to assist another member, regardless of the working status of the member Mi. The display control unit 1003 may display the members M[1] to [m] as candidates of the assistance request destination such that the members with the rejection setting made be distinguished readily.

The above-described functional units of the search display apparatus 201 may be, for example, implemented by a plurality of computers (for example, the search display apparatus 201 and the client terminal Ti) in the information processing system 200. Among the functional units of the search display apparatus 201, the identification unit 1002 may be implemented by the working status calculation engine 201-1, for example. The calculation unit 1006 may be implemented by the relevance degree calculation engine 201-2, for example. The display control unit 1003 may be implemented by the display portal 201-4, for example.

(Example of Identifying Working Status of Member)

An example of identifying the working status of the member Mi will be described.

It is first assumed that the member Mi is using browser software. In this case, the acquisition unit 1001 acquires, for example, the page transition amount for last 30 seconds as the work volume of the member Mi. Here, the page transition amount of the member Mi is assumed to be “4”. The average page transition of the member Mi is assumed to be “2.4”.

The identification unit 1002 calculates the work progress of the member Mi using the aforementioned expression (1). Here, the work progress of the member Mi is then 0.6 (=2.4/4).

The stress status of the member Mi is assumed to be “high”, and the feeling thereof is assumed to be “pleasure”. In this case, the identification unit 1002 identifies the weight as “1” corresponding to the feeling “pleasure” and the stress status “high” of the member Mi with reference to the weight table 240. The identification unit 1002 multiplies the calculated work progress “0.6” by the weight “1” to calculate the working status value as “0.6”.

The identification unit 1002 identifies the working status of the member Mi as the working status “good” corresponding to the calculated working status value “0.6” with reference to the working status classification table 250. The working status of the member Mi who is using browser software is thus identified as “good”.

It is assumed that the member Mi is using a different type of software from browser software. In this case, the acquisition unit 1001 acquires the amounts of mouse movement and keyboard input for last 30 seconds as the work volume of the member Mi. Here, the amount of mouse movement of the member Mi is assumed to be “0.2 m”, and the amount of keyboard input is assumed to be “14 inputs”.

The average mouse movement of the member Mi is assumed to be “0.4 m”, and the average keyboard input is assumed to be “10 inputs”. In this case, the mouse movement ratio is “0.2/0.4”. The keyboard input ratio is “14/10”. The mouse input time for last 30 seconds is assumed to be “12 seconds”, and the keyboard input time is assumed to be “18 seconds”.

The identification unit 1002 calculates the work progress of the member Mi using the aforementioned expression (2). Here, the work progress of the member Mi is 1.12 (=(12/30)×(0.2/0.4)+(18/30)×(14/10)).

The stress status of the member Mi is assumed to be “moderate”, and the feeling of the member Mi is assumed to be “anger”. In this case, the identification unit 1002 identifies the weight as “0.3” corresponding to the feeling “anger” and the stress status “moderate” of the member Mi with reference to the weight table 240. The identification unit 1002 multiplies the calculated work progress “1.12” by the weight “0.3” to calculate the working status value as “0.336”.

The identification unit 1002 identifies the working status of the member Mi as the working status “poor” corresponding to the calculated working status value “0.336” with reference to the working status classification table 250. The working status of the member Mi who is using a different type of software from browser software thus is identified as the working status “poor”.

(Example of Determining Whether Member Mj Is Working on Program Development)

An example of determining whether the assistance target member Mj is working on program development will be described using FIG. 11.

FIG. 11 is a diagram illustrating a specific example of the display image. In FIG. 11, a display image 1100 is a display image of the client terminal Tj of the assistance target member Mj and represents the contents displayed on the display 405 with the display portal screen (for example, the display portal screen 1200 illustrated in FIG. 12) closed.

The display image 1100 includes an editor screen 1101. The editor screen 1101 is an operation screen for inputting a program code. In this case, for example, when the search unit 1005 analyzes the display image 1100 and detects the editor screen 1101 with any program code inputted, the search unit 1005 determines that the assistance target member Mj is working on program development.

When the assistance target member Mj is using browser software, the search unit 1005 may determine that the assistance target member Mj is working on program development in a case detecting a particular keyword inputted in a search box, for example. The particular keyword is a previously set keyword related to program development, for example.

(Screen Example of Display Portal Screen)

Screen examples of the display portal screen displayed in the client terminal Ti will be described using FIGS. 12 to 15. Here, the monitored members M1 to Mn are assumed to be “members M1 to M10”.

FIGS. 12 to 15 are diagrams illustrating screen examples of the display portal screen. In FIG. 12, the display portal screen 1200 is an example of the operation screen that displays face icons I1 to I10 corresponding to the working status of the respective members M1 to M10, in association with the member information sets 1201 to 1210 of each of the members M1 to M10. Each of the member information sets 1201 to 1210 includes the name and captured image of the corresponding members M1 to M10.

According to the display portal screen 1200, each member Mi is able to intuitively determine the working status of the respective members M1 to M10 based on the face icons I1 to I10. This allows the manager to easily manage the working status of the respective members M1 to M10, for example. For example, the manager is able to determine based on the icon 18, that the working status of the member M8 is “poor”. In this case, for example, the manager is able to take action, such as identifying the members M1 and M7 whose working status is excellent based on the icons I1 and I7 and requesting the members M1 and M7 to assist the member M8.

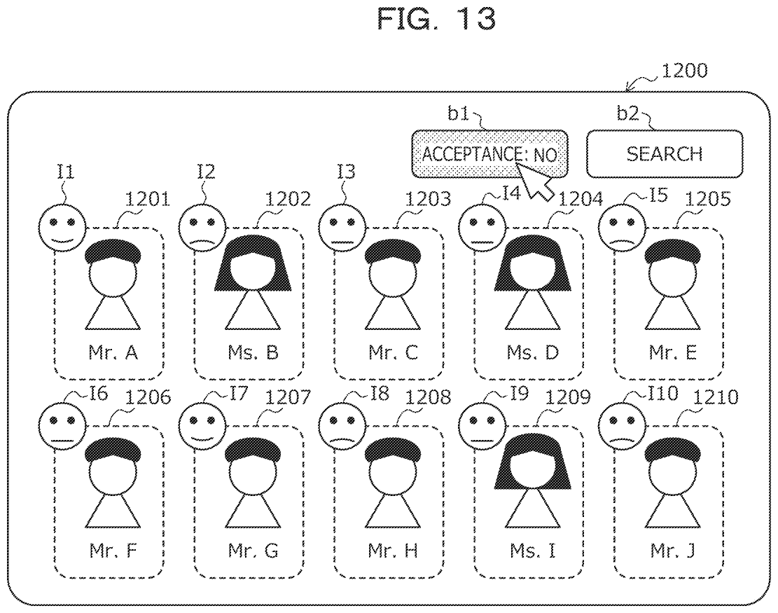

As illustrated in FIG. 13, when an accept button b1 is selected in the display portal screen 1200 by an operation input of the member Mi with the input device 406, the rejection setting is made. For example, the member Mi of the client terminal Ti is assumed to be the “member Ml”. In this case, when the accept button b1 is selected in the display portal screen 1200 by an operation input of the member M1, the rejection setting is made for the member M1.

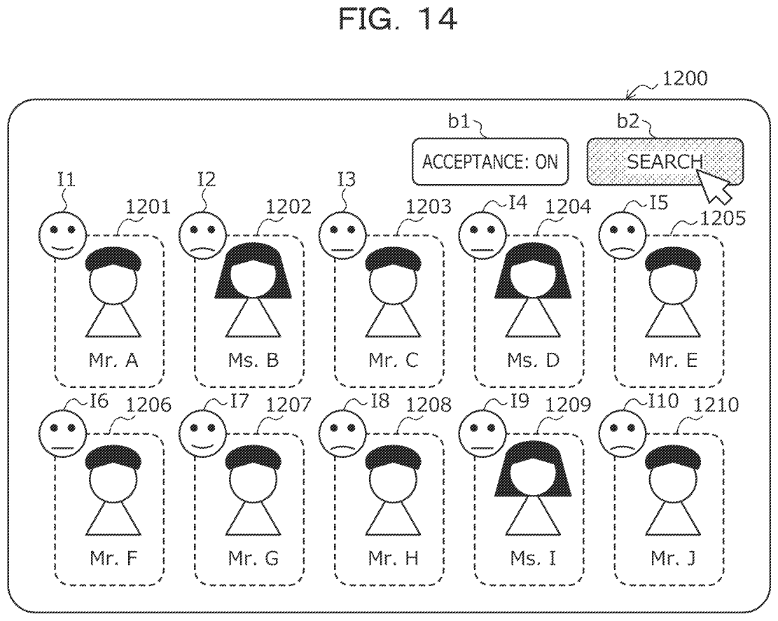

As illustrated in FIG. 14, when a search button b2 is selected in the display portal screen 1200 by an operation input of the member Mi with the input device 406, a search request for candidates of the assistance request destination is made. For example, the member Mi of the client terminal Ti is assumed to be the “member M8”. The member M8 is a member who is stuck at work and is in a poor working status.

In this case, when the search button b2 is selected in the display portal screen 1200 by an operation input of the member M8, a search request for candidates of the assistance request destination is sent from the client terminal T8 to the search display apparatus 201. As the result, for example, an assistance request destination list 1500 pops up in the display portal screen 1200 as illustrated in FIG. 15.

In FIG. 15, the assistance request destination list 1500 is a list of candidates of the destination to be requested to assist the member M8 (the assistance target member). Here, it is assumed that members M1, M6, and M9 are retrieved as the candidates of the assistance request destination for the member M8.

The assistance request destination list 1500 includes request destination candidate information sets 1501 to 1503. The request destination candidate information sets 1501 to 1503 are sorted based on the working status of the respective members M1, M6, and M9 and the degree of relevance between each of the members M1, M6, and M9 and the member M8. The request destination candidate information sets 1501 to 1503 include the name, captured image, face icon, number of responses, and acceptance information of the respective members M1, M6, and M9 which are the candidates of the assistance request destination.

For example, the request destination candidate information set 1501 includes the name “A” of the member M1, the captured image 1501-1, the face icon I1, the number of responses “18”, and the acceptance information “x”. The acceptance information “x” indicates that the rejection setting to reject a request to assist another member is made. The acceptance information “o” indicates that the rejection setting is not made.

The member M8 thus is able to retrieve members who will help the member MB's work. Since in the assistance request status thereof, from the acceptance information of the respective request destination candidate information sets 1501 to 1503.

As for Mr. F (the member M6) and Ms. I (the member M9) in the same working status, Mr. F is displayed above Ms. I. The member M8 is able to determine that Mr. F is more relevant to the member M8 than Ms. I and is more likely to respond to the member M8's question. Since the number of responses by Mr. F is greater than that by the other members, the member M8 understands that Mr. F has frequently responded to questions. The number of responses by each member Mi is recorded in the search display apparatus 201, for example.

(Various Processing of Search Display Apparatus)

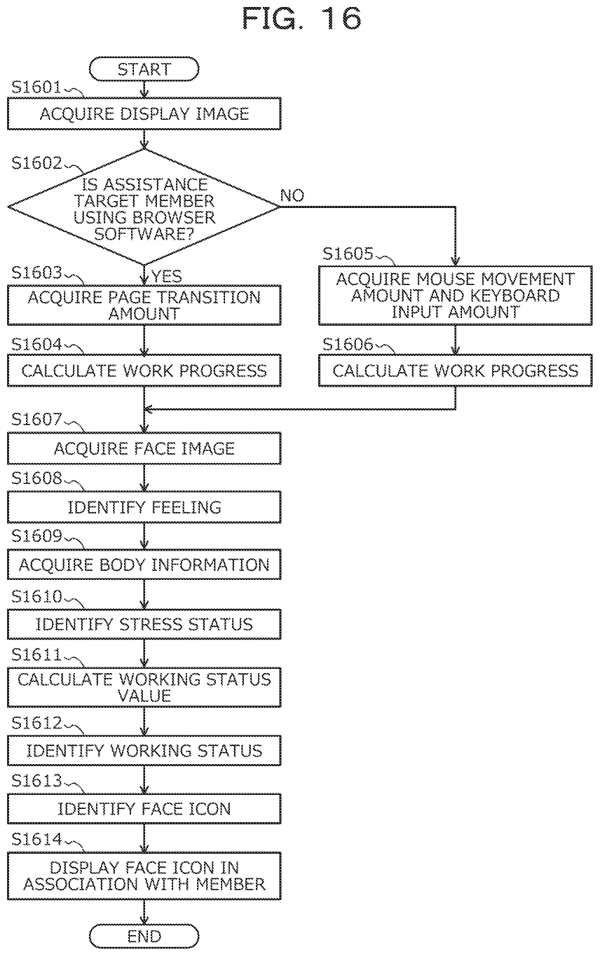

Various processing of the search display apparatus 201 will be described. First, a working status display processing of the search display apparatus 201 will be described using FIG. 16. The working status display processing of the search display apparatus 201 is, for example, regularly executed for each client terminal Ti of the client terminals T1 to Tn at intervals of 30 seconds.

FIG. 16 is a flowchart illustrating an example of the working status display processing of the search display apparatus 201. In the flowchart of FIG. 16, first, the search display apparatus 201 acquires a display image from the client terminal Ti (step S1601).

The client terminal Ti, for example, acquires a display image by recording the contents displayed on the display 405 as a still image through screenshot in response to a request from the search display apparatus 201. The client terminal Ti sends the acquired display image to the search display apparatus 201.

Based on the acquired display image, the search display apparatus 201 determines whether the member Mi is using browser software (step S1602). If the member Mi is using browser software (step S1602: Yes), the search display apparatus 201 acquires the page transition amount of the member Mi for last 30 seconds (step S1603). destination list 1500, the candidates of the assistance request destination are sorted in descending order of the working status, the member M8 is able to easily determine a member who is likely to be in a situation where the member may respond to the member M8's question, for example. The member M8 is able to recognize that Mr. A (member M1) is rejecting a request to assist another member regardless of the working

The search display apparatus 201 calculates the work progress of the member Mi based on the acquired page transition amount of the member Mi and the average page transition of the member Mi with reference to the work volume management DB 230 (step S1604) and then moves to step S1607.

If the member Mi is not using browser software in step S1602 (step S1602: No), the search display apparatus 201 acquires the amounts of mouse movement and keyboard input of the member Mi for last 30 seconds (step S1605).

The search display apparatus 201 calculates the work progress of the member Mi based on the acquired amounts of mouse movement and keyboard input of the member Mi and the average mouse movement and average keyboard input of the member Mi with reference to the work volume management DB 230 (step S1606).

The search display apparatus 201 acquires the face image of the member Mi from the client terminal Ti (step S1607). The client terminal Ti, for example, captures an image of the member Mi with the camera 404 to acquire the face image (the captured image) of the member Mi in response to a request from the search display apparatus 201. The client terminal Ti sends the acquired face image (captured image) to the search display apparatus 201.

The search display apparatus 201 then analyzes the acquired face image of the member Mi to identify the feeling of the member Mi (step S1608). The search display apparatus 201 acquires body information representing the heart rate of the member Mi from the sensing device Ci (step S1609).

Based on the acquired body information of the member Mi, the search display apparatus 201 identifies the stress status of the member Mi with reference to the work volume management DB 230 (step S1610). The sensing device Ci, for example, acquires the last measured body information and sends the acquired body information to the search display apparatus 201 in response to a request from the search display apparatus 201.

The search display apparatus 201 calculates the working status value of the member Mi by multiplying the calculated work progress by a weight corresponding to the identified feeling and stress status with reference to the weight table 240 (step S1611). The search display apparatus 201 identifies the working status of the member Mi as the working status corresponding to the calculated working status value with reference to the working status classification table 250 (step S1612).

The search display apparatus 201 identifies the face icon corresponding to the identified working status with reference to the working status classification table 250 (step S1613). The search display apparatus 201 displays the identified face icon in association with the member Mi (step S1614) and terminates the series of processes in the flowchart.

The search display apparatus 201 is able to identify the working status of the member Mi in the light of not only the work volume of the member Mi but also the stress status and feeling of the member Mi. The search display apparatus 201 is able to display the working status of the member Mi in association with the member Mi so as to allow intuitive determination thereof.

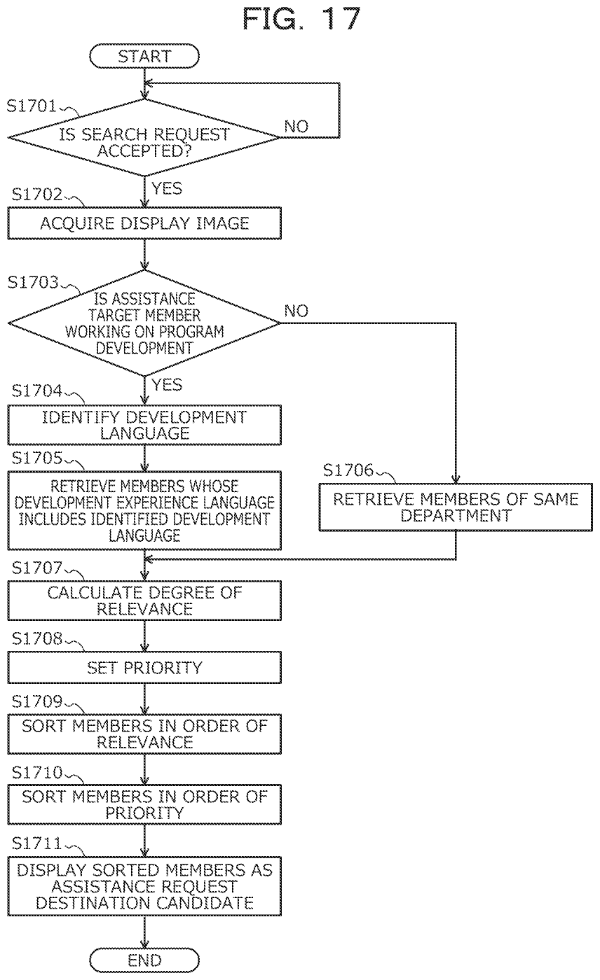

A search display processing of the search display apparatus 201 will be described using FIG. 17.

FIG. 17 is a flowchart illustrating an example of the search display processing of the search display apparatus 201. In the flowchart of FIG. 17, first, the search display apparatus 201 determines whether a search request for candidates of the assistance request destination is accepted from the client terminal Tj (step S1701).

The search display apparatus 201 waits for acceptance of the search request for candidates of the assistance request destination (step S1701: No). If the search request for candidates of the assistance request destination is accepted (step S1701: Yes), the search display apparatus 201 acquires a display image from the client terminal Tj (step S1702).

Based on the acquired display image, the search display apparatus 201 determines whether the assistance target member Mj is working on program development (step S1703). If the assistance target member Mj is working on program development (step S1703: Yes), the search display apparatus 201 identifies the development language in use based on the acquired display image (step S1704).

The search display apparatus 201 retrieves members (except the assistance target member Mj) whose development experience language includes the identified development language with reference to the member management DB 220 (step S1705) and moves to step S1707.

If the assistance target member Mj is not working on program development in step S1703 (step S1703: No), the search display apparatus 201 retrieves members (except the assistance target member Mj) whose department is the same as that of the assistance target member Mj with reference to the member management DB 220 (step S1706).

Here, the retrieved members are referred to as “members M[1] to [m]”, and arbitrary member among the members M[1] to [m] is referred to as a “member M[k]”.

With reference to the member management DB 220, the search display apparatus 201 calculates the degree of relevance between each member M[k] of the retrieved members M[1] to [m] and the assistance target member Mj (step S1707). The search display apparatus 201 sets a priority on each of the retrieved members M[k] as the assistance request destination based on the identified working status of the respective member M[k] (step S1708).

The search display apparatus 201 sorts the members M[1] to [m] in descending order of the degree of relevance calculated for each member M[k](step S1709). The search display apparatus 201 further sorts the sorted members M[1] to [m] in order of priority set on each member m[k] (step S1710).

The search display apparatus 201 displays the sorted members M[1] to [m] as candidates of the assistance request destination in the client terminal Tj (step S1711) and terminates the series of processes in the flowchart. In step S1711, the search display apparatus 201 may display the face icons corresponding to the respective working status of the respective members M[1] to [m] in association with the members M[1] to [m].

The search display apparatus 201 thereby facilitates retrieval of members suitable for the assistance request destination for the assistance target member Mj.

When the result of retrieval includes a single member, the search display apparatus 201, for example, skips the processing of steps S1707 to S1710 to display the retrieved member on the client terminal Tj as the candidate of the assistance request destination.

As described above, according to the search display apparatus 201 of the embodiment, it is possible to identify the working status of each member M[k] of the members M[1] to [m] based on the work volume of each member M[k]. According to the search display apparatus 201, it is possible to determine a priority for each member M[k] as the assistance request destination based on the identified working status of each member M[k] and display the members M[1] to [m] as candidates of the assistance request destination based on the priority determined for each member M[k].

The search display apparatus 201 facilitates retrieval of a member suitable for the assistance request destination from the members M[1] to [m]. For example, the search display apparatus 201 is able to preferentially display members who are working more smoothly among the members M[1] to [m] as candidates of the assistance request destination. At requesting someone to assist a member stuck at work, for example, the manager therefore is able to easily retrieve a member M[k] who is likely to respond to the request, from the members M[1] to [m]. The search display apparatus 201 is able to identify the working status of each member M[k] in real time by regularly acquiring the work volume of each member M[k] and consecutively identifying the working status based on the acquired work volume.

According to the search display apparatus 201, it is possible to identify the working status of each member M[k] based on the stress status identified depending on the body information of each of the member M[k]. The body information indicates, for example, the heart rate of each member M[k]. For example, the search display apparatus 201 may identify the stress status of the member M[k] by comparing the heart rate of the member M[k] with the previous-day's average heart rate of the member M[k].

The search display apparatus 201 therefore is able to identify the working status of the member M[k] in the light of not only the work volume of the member M[k] but also the stress status of the member M[k].

According to the search display apparatus 201, it is possible to identify the working status of each member M[k] according to the feeling analyzed based on the captured face image of the respective member M[k]. The feeling is, for example, represented by pleasure, anger, sadness, and happiness.

The search display apparatus 201 therefore is able to identify the working status of each member M[k] in the light of not only the work volume of the member M[k] but also the feeling of the member M[k].

According to the search display apparatus 201, at displaying the members M[1] to [m] as candidates of the assistance request destination, it is possible to display an icon corresponding to the working status of each member M[k] in association with each member M[k]. The icon is, for example, a face icon (a face mark). For example, the search display apparatus 201 is able to express whether or not the working status of each member M[k] is good, through different expression of the face icon (face mark).

The search display apparatus 201 therefore facilitates intuitive understanding of the working status of each member M[k] even if there are many candidates for the assistance request destination.

According to the search display apparatus 201, it is possible to identify the working status of each member M[k] based on the work volume including at least one of the page transition amount of each member M[k] during use of browser software and the operation amount for the input device 406 during use of a different type of software from browser software. For example, for the member M[k] who is using browser software, the search display apparatus 201 is able to identify the working status of the member M[k] based on the page transition amount during use of browser software. For the member M[k] who is using a different type of software from browser software, the search display apparatus 201 is able to identify the working status of the member M[k] based on the operation amount for the input device 406.

For a member M[k] who is using browser software, the search display apparatus 201 is able to identify the working status of the member M[k] by determining the working situation of the member M[k], such as whether the member M[k] is working smoothly or whether the member M[k] is stuck at work, based on the page transition amount during use of browser software. For a member M[k] who is using a different type of software from browser software, the search display apparatus 201 is able to identify the working status of the member M[k] by determining the working situation of the member M[k], such as whether the member M[k] is working smoothly or whether the member M[k] is stuck at work, based on the operation amount for the input device 406 (a mouse and a keyboard, for example).

According to the search display apparatus 201, it is possible to calculate the degree of relevance between each member M[k] and the assistance target member Mj based on the attribute information of the each member M[k] and the attribute information of the assistance target member Mj and display the members M[1] to [m] as candidates of the assistance request destination based on the calculated degree of relevance and the determined priority. The attribute information is information identifying, for example, the age, sex, year-of-joining, department, and development experience language.

The search display apparatus 201 thus is able to preferentially display members more relevant to the assistance target member Mj, for example, such as members of around the same age as the assistance target member Mj, members whose year-of-joining is close to that of the assistance target member Mj, or members of the same sex as that of the assistance target member Mj. For example, the manager easily retrieves from the members M[1] to [m], a member M[k] to whom the assistance target member Mj may easily make a question or a member M[k] who is likely to respond to questions.

According to the search display apparatus 201, it is possible to determine whether the assistance target member Mj is working on program development, based on the display image of the assistance target member Mj. According to the search display apparatus 201, if the assistance target member Mj is determined to be working on program development, it is possible to identify the development language that the assistance target member Mj is using, based on the display image of the assistance target member Mj and retrieve, as the members M[1] to [m], from the members M1 to Mn (monitored members), a member who has experience in using the identified development language.

When the assistance target member Mj is working on program development, the search display apparatus 201 therefore is able to narrow down the candidates of the assistance request destination to the members M[1] to [m] who are likely to respond to questions related to program development.

According to the search display apparatus 201, when the assistance target member Mj is determined to be not working on program development, it is possible to retrieve as the members M[1] to [m], members who belong to the same group as the assistance target member Mj from the members M1 to Mn, based on the attribute information of each member Mi of the members M1 to Mn and the attribute information of the assistance target member Mj.

When the assistance target member Mj is doing work different from work on program development, therefore, the search display apparatus 201 is able to narrow down candidates of the assistance request destination to, for example, the members M[1] to [m] whose year-of-joining, department, or the like is the same as that of the assistance target member Mj and who are likely to have similar experience to the assistance target member Mj.

According to the search display apparatus 201, it is possible to facilitate retrieval of members suitable for the assistance request destination when any member is stuck at work during remote working or in any difficult situation. For example, if the manager finds a member being in a poor working status among the members M1 to Mn while monitoring the working status of each member Mi, the manager is able to easily retrieve a member suitable for the assistance request destination and request the retrieved member to assist. The member Mi, when being stuck at work or in any difficult situation, is able to easily retrieve a member suitable for the assistance request destination and request the retrieved member to assist.

The display method described in this embodiment may be implemented by executing a program prepared in advance on a computer such as a personal computer or a workstation. The display program is recorded on a computer-readable recording medium such as a hard disk, a flexible disk, a CD-ROM, a DVD, or a USB memory, and is executed by being read by the computer from the recording medium. The display program may also be distributed via a network such as the Internet.

The search display apparatus 201 (information processing apparatus 101) described in the present embodiment may also be implemented by an integrated circuit (IC) for specific application, such as a standard cell or a structured application-specific integrated circuit (ASIC), or by a programmable logic device (PLD), such as a field-programmable gate array (FPGA).

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a program for causing a computer to execute a process, the process comprising:
identifying a working status of each of plural members based on a work volume of each of the plural members;
determining a priority for each of the plural members as an assistance request destination based on the identified working status of each of the plural members; and
displaying the plural members as candidates of the assistance request destination based on the determined priority for each of the plural members.

2. The non-transitory computer-readable recording medium according to claim 1, the process further comprising:
identifying the working status of each of the plural members based on a stress status identified according to body information of each of the plural members.

3. The non-transitory computer-readable recording medium according to claim 1, the process further comprising:
identifying the working status of each of the plural members according to feeling analyzed based on a captured face image of each of the plural members.

4. The non-transitory computer-readable recording medium according to claim 1, the process further comprising:
displaying an icon according to the working status of each of the plural members in association with each of the plural members.

5. The non-transitory computer-readable recording medium according to claim 1, wherein the work volume includes at least one of a page transition amount during use of browser software and an operation amount for an input device during use of a different type of software from the browser software.

6. The non-transitory computer-readable recording medium according to claim 5, the process further comprising:
identifying the working status of a member who is using the browser software based on the page transition amount during use of the browser software; and
identifying the working status of a member who is using the different type of software from the browser software based on the operation amount for the input device.

7. The non-transitory computer-readable recording medium according to claim 1, the process further comprising:
calculating a degree of relevance between each of the plural members and a member to be assisted based on attribute information of the plural members and attribute information of the member to be assisted; and
displaying the plural members as the candidates of the assistance request destination based on the degree of relevance and the priority.

8. The non-transitory computer-readable recording medium according to claim 1, the process further comprising:
determining whether a member to be assisted is doing a work related to program development based on a display image of the member to be assisted;
when it is determined that the member to be assisted is doing the work related to program development, identifying a development language that the member to be assisted is using, based on the display image of the member to be assisted; and
retrieving from a member set, the plural members who have experience in using the identified development language.

9. The non-transitory computer-readable recording medium according to claim 8, the process further comprising:
when it is determined that the member to be assisted is not doing the work related to program development, retrieving from the member set, the plural members who belong to a same group as that of the member to be assisted, based on the attribute information of each member of the member set and attribute information of the member to be assisted.

10. The non-transitory computer-readable recording medium according to claim 2, wherein the body information represents a heart rate.

11. A display method, comprising:
identifying, by a computer, a working status of each of plural members based on a work volume of each of the plural members;
determining a priority for each of the plural members as an assistance request destination based on the identified working status of each of the plural members; and
displaying the plural members as candidates of the assistance request destination based on the determined priority for each of the plural members.

12. An information processing apparatus, comprising:
a memory; and
a processor coupled to the memory and the processor configured to:
identify a working status of each of plural members based on a work volume of each of the plural members;
determine a priority for each of the plural members as an assistance request destination based on the identified working status of each of the plural members; and
display the plural members as candidates of the assistance request destination based on the determined priority for each of the plural members.
